(19) United States
(12) Patent Application Publication
(10) Pub. No.: US 2018/0224322 A1
(43) Pub. Date: Aug. 9, 2018

(54) UNIVERSAL APPLIANCE COMPRISING WEIGHT SENSING TECHNOLOGY

(71) Applicant: Clarence Wheeler, Atlanta, GA (US)

(72) Inventor: Clarence Wheeler, Atlanta, GA (US)

(21) Appl. No.: 15/919,186

(22) Filed: Mar. 12, 2018

Related U.S. Application Data
(60) Provisional application No. 62/470,233, filed on Mar. 11, 2017.

(51) Int. Cl. G01G 19/56; G01G 19/62; G01G 23/36; F24C 15/00; D06F 58/28

(52) U.S. Cl. CPC G01G 19/56; G01G 19/62; G01G 23/36; F25D 2700/06; D06F 58/28; F25D 2500/06; F24C 15/00

(57) ABSTRACT

An universal appliance comprising. A washer/dryer, cooking stove, and microwave type of appliance. The invention further comprises a weighting component for sensing load capacity's. A weight system sensor configured to transmit load capacity data information signals to a controller. Further, the invention comprises a bracket assembly configured to house a weighting component. Furthermore, the invention comprises oven rack holder that may support a rack and determine a load capacity.

### BACKGROUND OF THE INVENTION

### Field of the Invention

This invention relates to the field of appliances and systems. More specifically, the invention comprises improved home appliances and systems which may traditionally upgrade the conventional appliance and system comprising weight sensing technology.

### Description of the Related Art

There are many different appliances used for different purposes to preform different operations. Appliances are electrical/mechanical machines which accomplish some household functions, such as cooling/heating, cooking or cleaning. They may be broken into two classification major and small appliances, major appliances, comprise major household appliances and may include air conditioners, dishwashers, deep freezers, refrigerators, kitchen stoves, water heaters, washer/dryer machines, and microwave ovens.

### BRIEF SUMMARY OF THE PRESENT INVENTION

The scope of the present invention relates to appliances. A cooking type of appliance may include a main body/case portion a door attached to the main body/case portion to open/close the appliance, the appliance may also include a food heating unit which may be used to heat or warm foods to a certain temperature. And a display for viewing output information etc. Further, another type of appliance may be a washer/dryer unit and may consist of a main body/case portion a cabinet portion where laundry may be inserted into, a door to open/close the laundry entrance, a tub portion within the cabinet, a drum within the tub portion, a motor device provided which may transfer a drive force to the drum to spin, and a display screen for viewing and choosing different tasks and operations, and may include a ventless and or heated pump drying system. Lastly, the above mentioned appliances may include a weighting system for sensing weight of an object and/or item in order to preform weight sensing tasks and operations. The mentioned appliances may further comprise a printed circuit board that includes various electronic components mounted thereon.

### BRIEF DESCRIPTION OF THE SEVERAL VIEWS OF THE DRAWINGS

FIG. 1 is a shape diagram illustrating an appliance according to an embodiment of the present disclosure.

FIG. 2 is a flowchart illustrating method steps for controlling weight sensing mode on an washer/dryer appliance.

FIG. 3 is a flowchart illustrating method steps for controlling weight sensing mode on an microwave oven appliance.

FIG. 4 is a flowchart illustrating method steps for controlling weight sensing mode on an cooking stove appliance.

FIG. 5A is an illustration of a washer/dryer appliance of the preferred embodiments.

FIG. 5B is an illustration of an cooking appliance oven portion of the preferred embodiments.

FIG. 5C is an illustration of an cooking appliance stove portion of the preferred embodiments.

FIG. 5D is an illustration of an microwave appliance of the preferred embodiments.

### DETAILED DESCRIPTION OF THE PREFERRED EMBODIMENT(S)

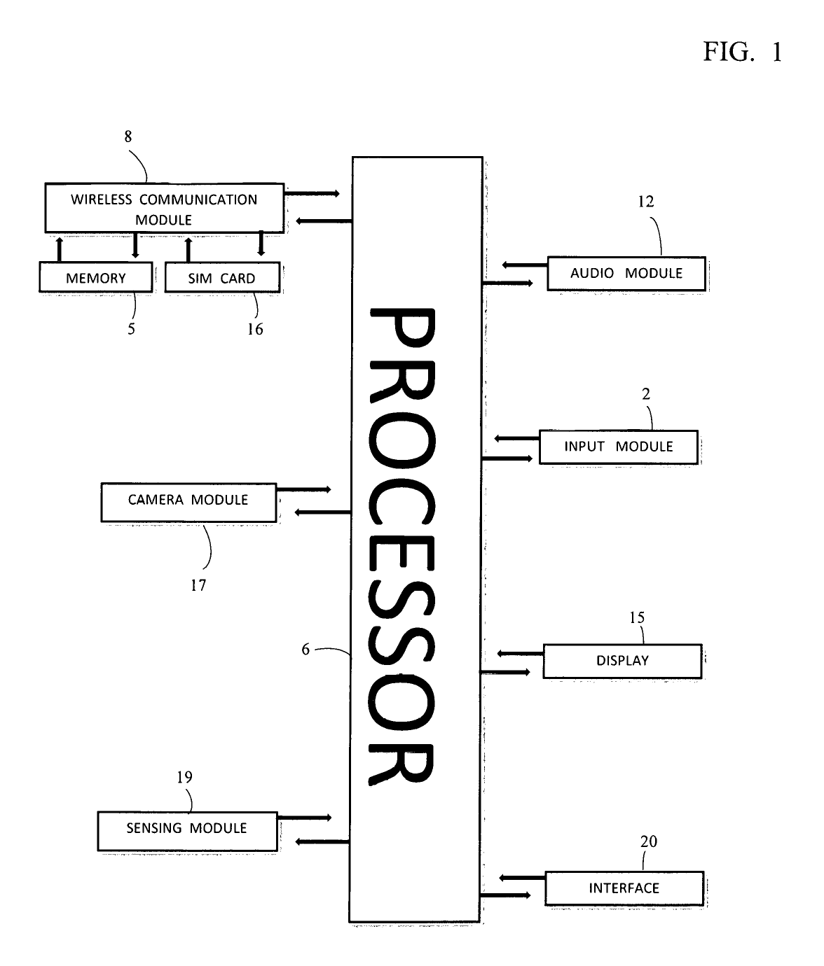

FIG. 1 is a shape diagram of an appliance 1 according to an embodiment of the present disclosure. The appliance 1 may include one or more processor 6 that may control the overall operations of the appliance 1, control hardware, software, components, and may also preform various data information processing and many other operations by executing an operating system and/or application program. The processor 6 may be implemented with a system on chip (SoC). Further, the processor 6 may include a graphic processing unit (GPU) and/or an image signal processor. For example, the processor 6 duties may be to load commands or data information received from at least one of the components (controller 21) to process load capacity data information signals and return load capacity data information signals into an actual number to the controller 21 and may store various data information in a nonvolatile memory.

The appliance 1 may include a cellular module 9, for example, may allow a user to place voice and video calls, text service, or internet service through a cellular communication network. The cellular module 9 may perform a distinction and authentication operation on the appliance 1 in a cellular communication network by using the SIM card (smart card). The cellular module 9 may also perform a part of a function provided by the processor 6, the cellular module 9 may also include a communication processor (CP).

The appliance 1 may include memory 5, that may comprise a SSD (Solid State Drive), NAS (Network Attached Storage), Dual-Channel RAM (Random Access Memory), Multi-ROM (Read-Only Memory), Flash Memory (Flash Memory Type), Hard Disk (Hard Disk Type), Multimedia Card Micro (Multimedia Card Micro Type), SRAM (Static Random Access Memory), EEPROM (Electrically Erasable Programmable Read-Only Memory), PROM (Programmable Read-Only Memory), may further include a card type memory Compact Flash (CF), Secure Digital (SD), Micro Micro-SD, Mini-SD, Extreme Digital (xD), Multimedia Card (MMC) or a memory stick. The external memory may be functionally and/or physically connected to the appliance 1, these above mentioned components may serve tasks as processing cores and dedicated graphics, and may store the appliance 1 operating system components, application data, display graphics and critical system files, many of the previously mentioned files and systems may be portioned to different storage chips throughout the appliance 1 main board or printed circuit board.

Additionally, the appliance 1 may include a wireless communication module 8, wireless communication module 8 allows wireless communication which may enable the remote interaction between the appliance 1 and a external device and or via internet, which may include communication systems as GSM (Global System for Mobile Communication) TDMA, CDMA (Code Division Multiple Access), PAN (Personal Area Network) NFC (Near Field Communication), Zigbee, Bluetooth, RFID (Radio Frequency Identification), IrDA, (Infrared Data Association), LAN (Local Area Network), WiFi, MAN (Metropolitan Area Network) WiMax (World Interoperability for Microwave Access), HSDPA (High Speed Downlink Packet Access), WAN (Wide Area Network), Wibro (Wireless Broadband), UMTS, LTE, 5 g and 6 g (5^{th} and 6 Generation Wireless System), OFDM (Orthogonal Frequency-Division Multiple Access), MC-CDMA (Multi-Carrier Code-Division Multiple-Access), LAS-CDMA (Large Area Synchronized Code Division Multiple Access), UWB (Ultra-Wideband), LMDS (Local Multiple Distribution Service), IPV6 (Internet Protcol Version 6), DMB-T (Digital Multimedia Broadcasting-Terrestrial), DMB-S (Digital Multimedia Broadcasting-Satellite), MediaFLO (Media Forward Link Only), DVB-H (Digital Video Broadcast-Handheld), ISDB-T (Integrated Services Digital Broadcast-Terrestrial), GNSS (Global Navigation Satellite System)/GPS (Global Positioning System), RF (Radio Frequency), Infrared, Broadcast Radio, and Microwave Communication Systems. Further, these variety's of wireless communication systems may be intergraded into the appliance 1 wireless communication module 8 intended to serve many different tasks which may be to transmit voice, video, and data information in local and wide range areas, by sending magnetism signals through the air, transmitters and receivers may be positioned at a certain position, using a aerial or antenna, at the transmitter the electrical signal leave the antenna to create electromagnetic waves that radiate outwards to wirelessly communicate. For example in FDMA, the transmitting and receiving frequencies used in each cell are different from the frequencies used in the neighboring cells. The principle of CDMA is more complex and the distributed transceivers can select one cell and listen to it. Other methods include Polarization Division Multiple Access (PDMA) and Time Division Multiple Access (TDMA). Time division multiple access is used in combination with either FDMA or CDMA to give multiple channels within the coverage area of a single cell. The wireless communication module 13 may include a processor for processing data transmitted/received through a corresponding module and or may be included in one integrated chip (IC) or IC package. The RF module 13, for example, may be used to transmit/receive communication signals. The RF module 13 may include a transceiver, a power amp module (PAM), a frequency filter, a low noise amplifier (LNA), or an antenna. A cellular module 9, WiFi module 3, BT module 14, GNSS module 7, and NFC module 10 may transmit/receive RF signals through a separate RF module. The appliance 1 may include a SIM 16 or a embedded SIM (Subscriber Identification Module (SIM)) a type of smart card used in mobile phones. The SIM is a detachable smart card containing the user's subscription information and phone book. This allows the user to retain his or her information even after switching off the handset. Alternatively, the SIM card may securely store the service subscriber key.

The appliance 1 may include a input module 2 which may be a key 18, touch panel (static pressure/electrostatic) 4, a ultrasonic input device 11, the touch panel 4 may use at least one of the capacitive, resistive, infrared, or ultrasonic method, for example. Additionally, the touch panel 4 may further include a control circuit, alternatively the touch panel 4 may further include a tactile layer to provide tactile response to a user. The key 14 may include a physical button, an optical key, or a keypad, the ultrasonic input module 11 may detect ultrasonic waves generated from an input tool through the audio module 12 in order to verify data corresponding to the detected ultrasonic waves.

Furthermore, the appliance 1 may include a camera module 17, and may substantially process a image frame, a still, moving, or both still and moving image and/or video obtain images, and may include image sensors (at various portion of the terminal 1) a lens, image signal processors (ISP), or a flash. Once a image and/or video is captured or stored these images may be transferred to the appliance 1 memory 5 or to a external device through the wireless communication module 8. The audio module 12 may include a microphone, speaker, and receiver these audio module 12 components may preform task as to receive an external sound from voice call mode, voice recognition and/or command mode, or voice assistance mode these sounds may be processed to the electrical voice data. Additionally, the appliance 1 audio module 12 may receive call mode, voice recognition, voice recording, and broadcast reception mode from the wireless communication module 8 and or output audio sound or sound data that may be stored inside of the appliance 1 memory 5, external storage, or transmitted from an external device.

The appliance 1 display 15 may be a LCD (Liquid Crystal Display), a thin film TLCD (Transistor-Liquid Crystal Display), OLED (Organic Light-Emitting Diode), 3-D Display (may include at least one of 3D displays) and may incorporate a touch sensor. Some of these displays may be configured to be transparent to view the outside through them. This may be called a transparent display, for example a transparent display and the like (Transparent Organic Light Emitting Diode) TOLED. The display 15 according to the implementation of the appliance 1 present may also be two or more. For example, it may be provided in the appliance 1 at the same time the external display module (not illustrated) and an internal display module (not illustrated). The touch screen may be configured to detect even a touch input as well as the position and area of the touch input pressure. The interface 20 may include a high-definition multimedia interface (HDMI), a universal serial bus (USB), an optical interface, or a D-subminiature (sub). Alternatively, the interface 20 may include a mobile high definition link (MHL) interface, secure digital (SD) card/multi-media card (MMC) interface, or an infrared data association (IrDA) standard interface.

The appliance 1 sensing module 19 may measure physical quantities or detect an operating state of the appliance 1, thereby converting the measured or detected information into electrical signals, and may accommodate many different sensors (ex. gesture sensor, gyro sensor, barometric sensor, magnetic sensor, acceleration sensor, grip sensor, proximity sensor, color sensor, biometric sensor, temperature/humidity sensor, illumination sensor, UV sensor, E-nose sensor, electromyography (EMG) sensor, electroencephalogram (EEG) sensor, electrocardiogram (ECG) sensor, infrared (IR) sensor, iris sensor, and/or a fingerprint sensor). The sensing module 19 may further include a control circuit which may control at least one sensor therein and a additional processor to control the sensing module 19 while the main processor 6 may be in a sleep or consumption state. For example sensing the current state of a appliance 1, such as opening or closing the appliance 1, the position of the appliance 1, a user contact presence, orientation of the appliance 1, acceleration/deceleration of the appliance 1 to generate a sensing signal for controlling the operation of the appliance 1. Additionally, the appliance 1 can sense the opening or closing of the door. Meanwhile, the sensing module 19 may include a proximity sensor.

Referring to the washer/dryer, microwave, and cooking stove appliance 1, each appliance 1 weighting system may differ in components and locations or may be similar.

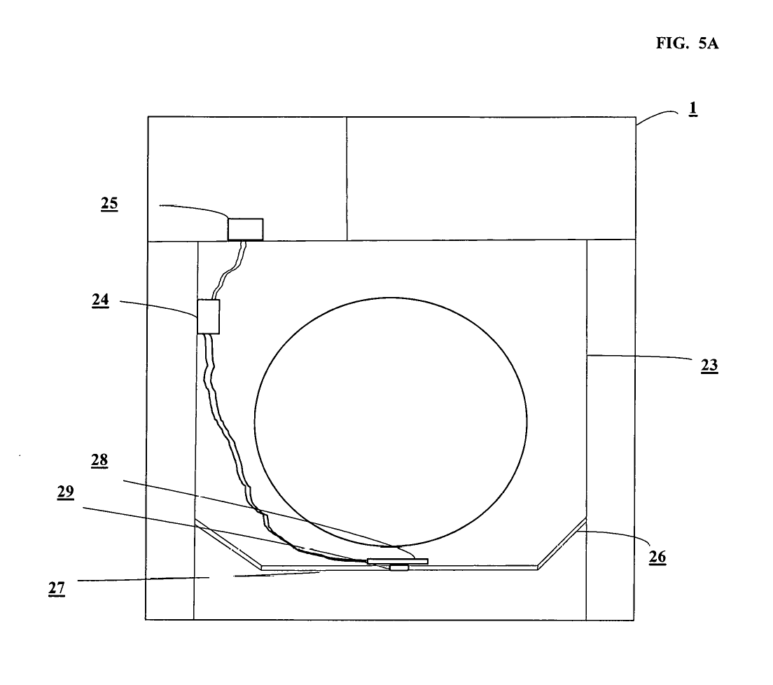

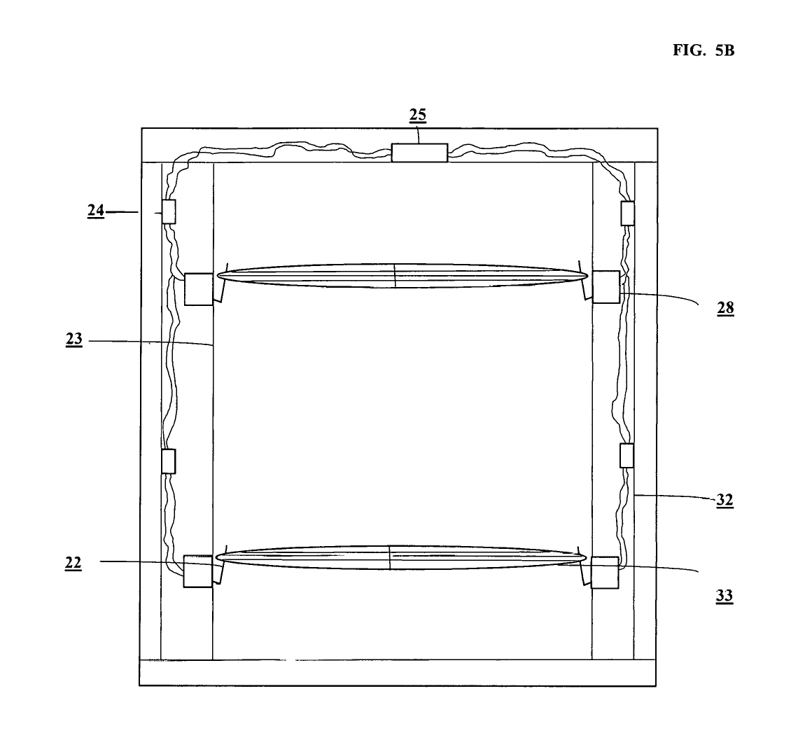

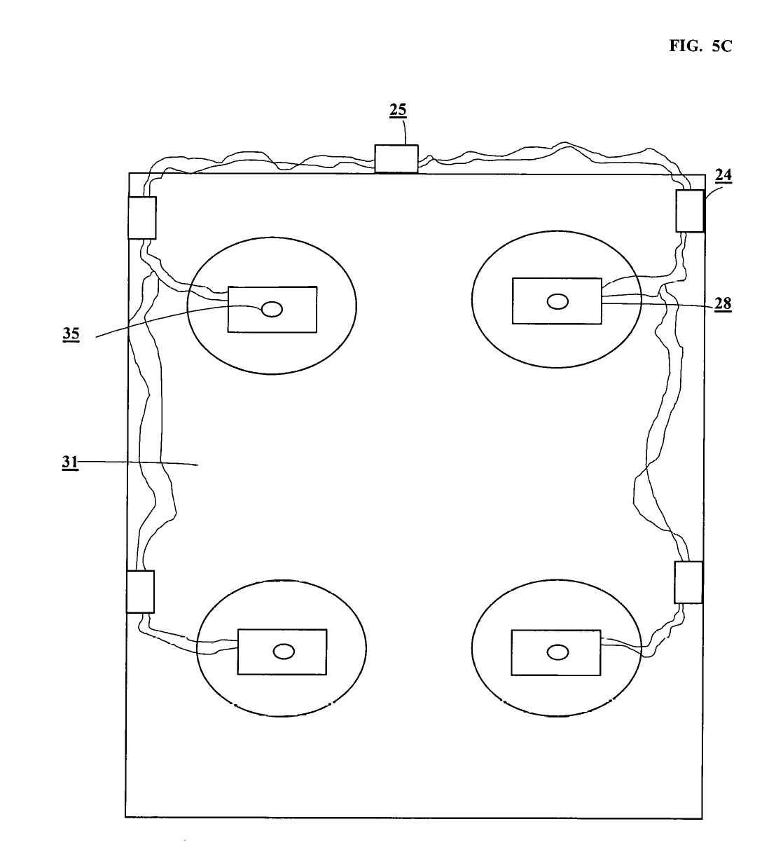

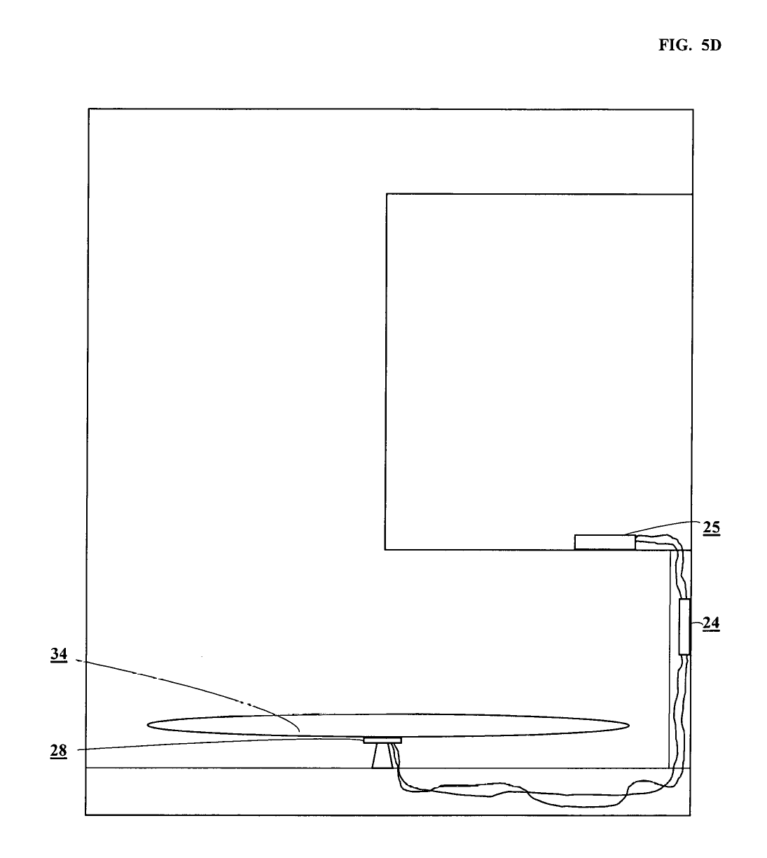

For example, the front loading washer/dyer appliance 1 may perform weight sensing due to the washer/dryer appliance 1 including a weighting system FIG. 5A, the weighting system may comprise a weight sensing component 28 that may sense an item(s) or object(s) load capacity and transmit a weight value to the weight system sensor 24 may be located inside of the washer/dryer appliance 1 and may be made of a metal, steel, or stainless steel material that may be heat resisting and waterproof More specifically, the weight sensing component 28 may be coupled to the bracket plate 29, whereas the bracket plate 29 may be made of a stainless-steel or metal material, positioned in the middle of the bracket assembly 27 either by screws or may be welded to the bracket plate 29, the bracket arms 26 may be coupled by (screwed) to the first side inner walls 23 of the inside body portion of the washer/dryer appliance 1. The bracket assembly 27 may be made of a flexible plastic or injection-molded material. The bracket plate 29 may run from the front bottom side of the drum 30 to the rear bottom side of the drum 30.

The weight sensing component 28 may be coupled to the weight system sensor 24 via a wire connection. Further, the weight system sensor 24 may be located inside of the body portion of the appliance 1 coupled to a first inner side wall 23, intended to return load capacity data information to the controller 21, whereas the weight system sensor 24 may be directly coupled to the mainboard/printed circuit-board 25 by a harness connection.

Hence, upon the load capacity data information transmitted from the weight system sensor 24 to the controller 21, in respect of the controller 21 the processor 6 may preform processing tasks as to converting the load capacity data information into a actual number. In response of the processor 6 preforming the processing task the controller 21 may output the load capacity data information on the washer/dryer appliance 1 display 15. According to a top loading washer/dryer appliance 1 the same weight sensing system and components may apply, differently the bracket assembly 27 may be positioned at the inner bottom portion due to the drum positioned vertically.

Furthermore, referring to the cooking stove appliance 1 FIG. 5C this type of appliance 1 may include multiple weight sensing components 28 at various locations that may be made of metal, stainless-steel, steel, heat resistant and waterproof material. Further, with the cooking stove appliance 1 each weighting component 28 may include their own separate weight system sensor 24. The cooking stove appliance 1 weight sensing components 28 may be positioned underneath the hood of the cooking stove appliance 1 coupled to the first top wall portion 31 (burner deck) at each burner position of the cooking stove appliance 1. Each weight sensing component 28 may be wired to a weight system sensor via a wire connection, each weight system sensor 24 may be coupled to a first inner wall 23 behind the cooking stove appliance 1 front panel. Each weight system sensor 24 may be coupled to the mainboard/printed circuit-board 25 via a harness connection intended to return load capacity data information signals to the controller 21.

Further, the oven portion FIG. 5B may include multiple weight sensing components 28. Furthermore, the weight sensing components 28 may be located inside of the oven body/cavity portion, coupled to a second inner side wall(s) 32 behind a first inner side wall(s) 23. Hence, the weight sensing components 28 may be positioned at the upper and bottom front and rear of the second inner side wall(s) 32 both left and right side. Additionally, the weight sensing components 28 may comprise oven rack holders 22, whereas the oven rack holder 22 may be coupled to the weight sensing components 28. Further, the oven rack holder 22 may be in the shape of a elbow or a (L), and may be made of a metal, stainless steel, steel, heat resisting and waterproof material. Furthermore, the oven rack holder 22 may protrude or extend from slots or holes positioned on the first inner side wall(s) 23 in front of the second side wall(s) 32 at each weight sensing component 28 position. Whereas, the elbow shape oven rack holder 22 allow the oven rack 33 to rest at the elbow portion as a hanging type. Substantially, once weight is applied to the oven rack holder 22 the rack holder 22 bends due to spring like action, whereas the spring inside of the weight sensing component 28 is coupled to one end of the rack holder 22 inside of the weight sensing component 28. Further, in response to the bending action from the rack holders 22 the weight sensing component 28 may output a load capacity signal(s) to the weight system sensor. Whereas, the weighting system sensor 24 may transmit the load capacity data information signal(s) to the controller 21 via harness connection from the weight system sensor 24 to the mainboard/printed circuit-board 25. In addition, the cooking stove appliance 1 weight system sensor(s) 24 may be located behind the appliance 1 front panel coupled to the first inner wall 23. Each weight sensing component 28 may be wired to a weight system sensor 24, whereas each weight system sensor 24 may be coupled to the mainboard/printed circuit-board 25 via a harness connection.

Further, referring to the microwave oven appliance 1 FIG. 5D this type of appliance 1 may include a weight sensing component 28 that may be made of a metal, stainless-steel, steel, heat resistant and waterproof material. Furthermore, the weight sensing component 28 may be located inside of the body/cavity portion of the microwave oven appliance 1, coupled at the center bottom base portion of the microwave oven cavity.

The weight sensing component 28 may be wired to a weight system sensor 24, the weight system sensor 24 may be located inside of the body/cavity wall(s).

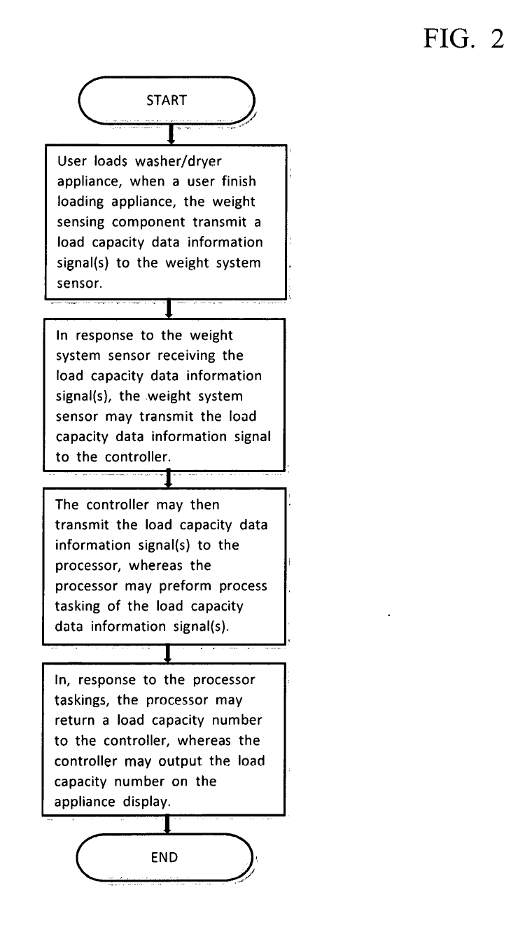

The weight system sensor 24 may be coupled to the mainboard/printed circuit-board 25 via a harness connection. The microwave oven appliance 1 cooking plate 34 may rest on top of the weight sensing component 28 once a item or object load capacity is sensed the weight sensing component 28 may output load capacity data information signal(s) to the weight system sensor 24. Whereas, in response to the output signal(s), the weight system sensor 24 may output the load capacity data information signal(s) to the controller 21 via harness connection to the mainboard/printed circuit-board 25. FIG. 2 is a flowchart illustrating step for a washer/dryer appliance in weight sensing mode and controlling of a washer/dryer appliance.

When in weight sensing mode, a user may choose washing and/or drying cycle type(s), upon a user input to the input module 2 the controller 21 may recognize this signal as a command for choosing a washing and/or drying cycle type this information may be output on the appliance 1 display 15. During weight sensing mode a user enters an item(s) into the washer/dryer appliance 1 drum 30 as the items are loaded into the drum 30 the weight sensing component 28 calculate each article of item(s), the load capacity may rise or decline due to a user adding or removing items.

Once a user is done adding or removing item(s) from the drum 30 the load capacity is calculated, this is possible as mentioned above whereas the weight sensing component 28 output the load capacity data information signal(s) to the weight system sensor 24 in response to the load capacity data information signal(s) output to the weight system sensor 24, the weight system sensor 24 may output the load capacity data information signal(s) to the controller 21. In respect of the controller 21 receiving the load capacity data information signal(s), the controller 21 may recognize this signal(s) as to transmitting the load capacity data information signa(s) to the processor 6, whereas the processor 6 may preform process task(s) as to returning the load capacity data information signal(s) to the controller 21 as a actual number. In response to the processor 6 returning a load capacity number value to the controller 21, further the controller 21 may output the load capacity number value on the display 15.

Furthermore, for example if a user decides to wash and dry item(s), the user may determine weather to stop the drying process at the original load capacity that was calculated when the item(s) where originally loaded or may choose a lighter load capacity meaning a dryer load. By a user input signal to the input module 2 whereas the controller 21 may recognize this command as a load capacity adjustment command this information may be output on the display 15. Hence, the washer/dryer appliance 1 may start performing the washing and/or drying task operation by a user input signal to the input module 2 the controller 21 may recognize this command as starting the selected washing and/or drying cycles. All the above mentioned information may be available on the weight sensing mode first screen whereas the weight sensing mode first screen may be output on the appliance 1 display 15.

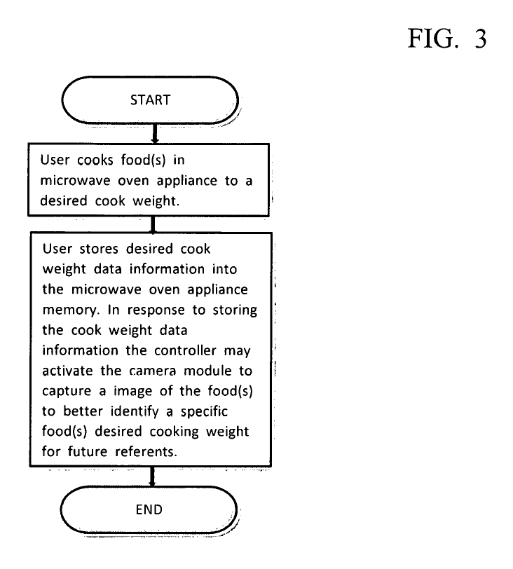

Referring to FIG. 3 is a flowchart illustrating method steps for controlling weight sensing mode on an microwave oven appliance 1. While in weight sensing mode a user may place a item(s) into the cooking plate 34 inside of the microwave oven appliance 1. Multiple circumstance's may apply during this process, for example frozen dinners a user may first have to cook a item(s) in order to determine the desired cooking weight of a user choice due to most food manufactures not including finished cooking weights on these type of item(s). Additionally, while in weight sensing mode a user may chose different task as to defrost and/or cook item(s) by a user input signal to the input module 2 the controller 21 may recognize this signal command as a cooking task command this information may be displayed on the display 15.

Further, when a user cooks a this type of item(s) a user may have to store the desired cook weight into the microwave oven appliance 1 memory 5, when a user has achieved its desired cook weight a user may store the desired cook weight into the microwave appliance 1 memory 5 while in weight sensing mode by a user input signal to the input module 2 the controller 21 may recognize this signal command as a storing item(s) weight command. The controller 21 may also activate the camera module 9 during the storing item(s) weight command, whereas a user may capture a image of the item(s) to stored by a user input signal to the input device 2 the controller 21 may recognize this command as a image capture command.

Once the controller 21 capture the image through the camera module 9 the actual desired weight of the item(s) may be input into the microwave appliance 1 memory 5, by a user input signal to the input module 2 the controller 21 may recognize this command a item(s) weight storing input command. Further, the controller 21 may group the item(s) image and weight information and transmit the information to the processor 6 for processing task operation once the processor 6 process this information the controller 21 may transmit the item(s) information to the memory 5. By a user input signal to the input module 2 the controller 21 may recognize this command as to saving a item(s) to the microwave appliance 1 memory 5. In the event of cook this same item(s), this specific item(s) information will be stored into the microwave appliance 1 memory 5. All the above mentioned information may be available on the weight sensing mode first screen whereas the weight sensing mode first screen may be output on the microwave appliance 1 display 15.

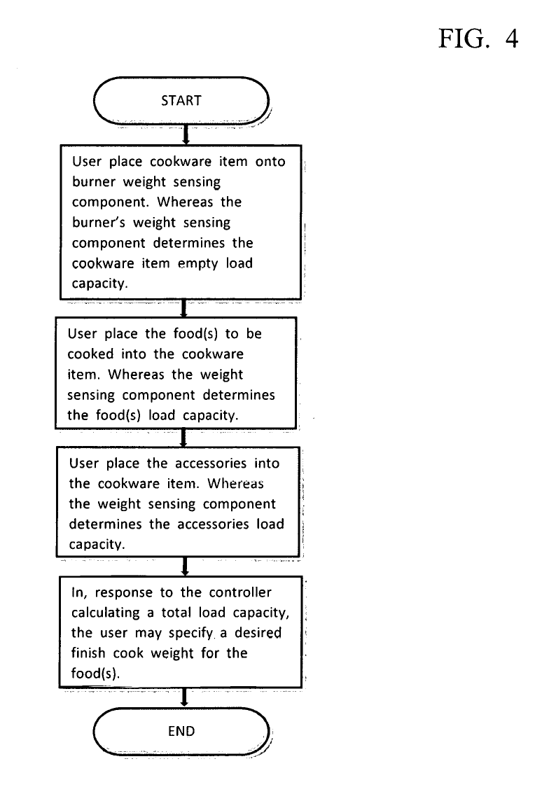

On to FIG. 4 is a flowchart illustrating method steps for controlling weight sensing mode on an cooking stove appliance. In weight sensing mode with a cooking stove appliance 1 a user may choose a plurality of task and operation.

For example, if a user choose to bake a turkey or roast in the oven portion and preset the oven, this is possible by a user input signal to the input module 2 whereas the controller 21 may recognize this input signal as an command for presetting the oven to a specific temperature.

While in weight sensing mode a user may place a cookware item (ex. pot, pan, skillet etc.) which the item(s) is to be stored and cooked in on one of the cooking stove appliance 1 burner 35 crate's due to the burner 35 portion including a weight sensing component 28.

During this stage the weight sensing component 28 may calculate the cookware item empty load capacity. Further, the weight sensing component 28 may transmit the cookware item empty load capacity data information signal(s) to the weight system sensor 24, whereas the weight system sensor 24 may transmit the empty cookware item load capacity data information signal(s) to the controller 21. Hence, in response of the controller 21 receiving the cookware item empty load capacity data information signal(s), the controller 21 may store the cookware item empty load capacity by a user input signal to the input module 2 the whereas controller 21 may recognize this signal command as a cookware item empty load capacity storing command.

In addition, the user may add food(s) (ex. turkey or roast) into the cookware item while the cookware item is still placed on the burner's 35 crate. At this point the weight component 28 may then calculate the total load capacity of the food(s) (ex. turkey or roast). Upon a user input signal to the input module 2 whereas the controller 21 may then recognize this as an command to storing a food(s) command.

Lastly, while the cookware item is still placed on the burner's 35 crate a user may add accessories to the cookware item (ex. water, oil, broth, vegetables, and/or fruits) the weight sensing component 28 may calculate the accessories load capacity. Further, the accessories load capacity may be stored by a user input signal to the input module 2, whereas the controller 21 may recognize this input signal command as to storing accessories load capacity. At this point user may select a desired cook weight by a user input signal to the input module 2 the controller 21 may recognize this command as a desired food weight command. Furthermore, the user may determine a set cooking temperature to begin the cooking task.

All the above mentioned information may be available on the weight sensing first screen the weight sensing first screen may be output on the microwave appliance 1 display 15. Although the preceding description contains significant detail, it should not be constructed as limiting the scope of the invention but rather as providing illustration of the preferred embodiments of the invention. As an example, the control features could take many different forms within the digital control panel menu structure. Such a variation would not materially alter the nature of the said invention. Thus, the scope of the invention should be fixed by the following claims rather than any specific examples provided. The load capacity data information processing method in an appliance 1 with the weight sensing component 28, weight system sensor 24, controller 21, and processor 6 according to the present invention may be executed through software. In this case, constituent means of the present invention are code segments carrying out required works. Programs or code segments may be stored in a processor 6 readable medium and transmitted according to computer data signals combined with carriers in a transmission medium or a communication network.

1-7. (canceled)

8. A washer/dryer appliance comprising:
a weigh sensing component for determining the load capacity of a item or object;
a weight system sensor that may transmit load capacity data information signal(s) to the controller;
a bracket assembly;
a controller; and
a processor.

9. The universal appliance of claim 1, wherein the weight sensing component may sense an item(s) or object(s) load capacity and return a weight value to the weight system sensor.

10. The universal appliance of claim 1, wherein the weight sensing component may be located inside of the appliance.

11. The universal appliance of claim 1, wherein the weight sensing component may be made of a metal, steel, or stainless-steel material that may be heat resisting and waterproof.

12. The universal appliance of claim 1, wherein the bracket assembly comprises bracket arms that may be coupled by (screwed) to the first side inner walls of the inside body portion of the washer/dryer appliance.

13. The universal appliance of claim 1, wherein the bracket assembly comprises a bracket plate that may run from the front bottom side of the drum to the rear bottom side of the drum.

14. The universal appliance of claim 3, whereas the weight sensing component may be coupled to the bracket plate, whereas the bracket plate may be made of a stainless-steel or metal material, positioned in the middle of the bracket assembly either by screws or may be welded to the bracket plate.

15. The universal appliance of claim 1, wherein the bracket assembly may be made of a flexible plastic or injection-molded material.

16. The universal appliance of claim 1, wherein the weight sensing component may be coupled to the weight system sensor via a wire connection.

17. The universal appliance of claim 1, wherein the weight system sensor may be located inside of the body portion of the appliance coupled to a first inner side wall.

18. The universal appliance of claim 1, wherein the weight system sensor intended to return load capacity data information to the controller, whereas the weight system sensor may be directly coupled to the mainboard or printed circuit-board by a harness connection.

19. The universal appliance of claim 11, whereas upon the load capacity data information transmitted from the weight system sensor to the controller, in respect of the controller the processor may preform processing tasks as to converting the load capacity data information into a actual number. In response of the processor preforming the processing task the controller may output the load capacity data information on the washer/dryer appliance display.

20. The universal appliance of claim 1, whereas according to a top loading washer/dryer appliance the same weight sensing system and components may apply, differently the bracket assembly may be positioned at the inner bottom portion due to the drum positioned vertically.

21. A cooking stove appliance comprising:
a weight sensing component for determining the load capacity of a item or object;
a weight system sensor that may transmit load capacity data information signal(s) to the controller;
a oven rack holder;
a controller; and
a processor.

22. The cooking stove appliance of claim 14, wherein the weight sensing components may be positioned underneath the hood of the cooking stove appliance coupled to the first top wall portion (burner deck) at each burner position of the cooking stove appliance.

23. The cooking stove appliance of claim 14, whereas each weight sensing component may be wired to a weight system sensor via a wire connection, each weight system sensor may be coupled to a first inner wall behind the cooking stove appliance front panel.

24. The cooking stove appliance of claim 14, whereas each weight system sensor may be coupled to the mainboard or printed circuit-board via a harness connection intended to return load capacity data information signals to the controller.

25. The cooking stove appliance of claim 14, whereas the oven portion may include multiple weight sensing components. Furthermore, the weight sensing components may be located inside of the oven body/cavity portion, coupled to a second inner side wall(s) behind a first inner side wall(s). Hence, the weight sensing components may be positioned at the upper and bottom front and rear of the second inner side wall(s) both left and right side.

26. The cooking stove appliance of claim 14, whereas the weight sensing components may comprise oven rack holders, whereas the oven rack holder may be coupled to the weight sensing components. Further, the oven rack holder may be in the shape of a elbow or a (L), and may be made of a metal, stainless steel, steel, heat resisting and waterproof material. Furthermore, the oven rack holder may protrude or extend from slots or holes positioned on the first inner side wall(s) in front of the second side wall(s) at each weight sensing component position.

27. The cooking stove appliance of claim 14, whereas once weight is applied to the oven rack holder the rack holder bends due to spring like action, whereas the spring inside of the weight sensing component is coupled to one end of the rack holder inside of the weight sensing component. Further, in response to the bending action from the rack holders the weight sensing component may output a load capacity signal(s) to the weight system sensor. Whereas, the weighting system sensor may transmit the load capacity data information signal(s) to the controller 21 via harness connection from the weight system sensor to the mainboard or printed circuit-board.
